(19) United States
(12) Patent Application Publication
(10) Pub. No.: US 2009/0204287 A1
(43) Pub. Date: Aug. 13, 2009

(54) Diagnostic System and Diagnostic Test with a WLAN Transmission Module

(75) Inventors: Martin Blanz, Schwieberdingen (DE); Thomas Bueckle, Bernstadt (DE); Gerald Grau, Waiblingen (DE); Ralf Lueg, Athengstett (DE); Manuel Rieger, Weinstadt-Schnait (DE); Markus Scholz, Winnenden (DE); Ralf Traub, Stuttgart (DE); Klaus Weiss, Gruibingen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/298,896

(22) PCT Filed: Apr. 4, 2007
(86) PCT No.: PCT/EP2007/003045

§ 371 Date: Mar. 18, 2009

(30) Foreign Application Priority Data
Apr. 29, 2006 (DE) 10 2006 019 972.3

(51) Int. Cl. G01M 17/00

(52) U.S. Cl. 701/33

(57) ABSTRACT

The invention relates to a motor vehicle diagnostic system for acquiring and storing diagnostic data and transmitting them from control units in a motor vehicle to a computer outside the motor vehicle. The system is composed of components which are located inside the vehicle and of components which are located outside the vehicle. Using a transmission module, in which a short diagnostic test is implemented, diagnostic data from onboard components are interrogated and are transmitted via a WLAN link to the computer system of a service company. The diagnostic data of the onboard components can be further processed using the computer system. The disclosed invention is aimed in particular at assisting a service employee in the vehicle reception of a service workshop.

This application is a national stage of International Application No. PCT/EP2007/003045, filed Apr. 4, 2007, which claims priority under 35 U.S.C. §119 to German Patent Application No. 10 2006 019 972.3, filed Apr. 29, 2006, the entire disclosure of which is herein expressly incorporated by reference.

### BACKGROUND AND SUMMARY OF THE INVENTION

The invention relates to a motor vehicle diagnostic system for acquiring and storing diagnostic data and transmitting them from control units in a motor vehicle to a computer outside the motor vehicle. The system is composed of components which are located both inside and outside the vehicle. Using a transmission module, in which a short diagnostic test is implemented, diagnostic data from onboard components are interrogated and are transmitted via a WLAN link to the computer system of a service company. The diagnostic data of the onboard components can be further processed using the computer system. The disclosed invention is aimed in particular at assisting a service employee in the vehicle reception of a service workshop.

A computer-assisted diagnostic system which uses a diagnostic program to produce a weighted list of the possibly faulty components of a motor vehicle from vehicle data and customer information is disclosed, for example, in German patent document DE 102005015664. The possible fault candidates are identified by evaluating a rule table which maps diagnostic knowledge. The troubleshooting space is expanded by additionally evaluating vehicle functions which are possibly also affected by the fault candidates. The service technician can restrict the troubleshooting to selected fault codes or functions by setting a focus within the determined troubleshooting space. Only the possible candidates for the selected fault codes or functions are then considered further. The fault candidates which are associated with this focus set are weighted for fault codes, components and affected functions by calculating a plurality of fault probabilities. Alternatively, for the calculation it is also possible to use known fault patterns; that is, associated fault codes which always occur together.

A focus is set for further, automated, troubleshooting, using an interactively operating diagnostic program in which the service technician, within a troubleshooting space initially defined by the diagnostic program, of the components or functions which are identified as possibly being defective. The focus can be set here by restriction to a fault code or to a function. In this diagnostic program, it is also possible to allow customer information on functioning and nonfunctioning component systems to be included in the diagnostic process. In particular, the diagnostic program permits the processing of only symptomatically known malfunctions, such as is usually the case when there are customer complaints.

German patent documents DE 19529741 A1 and DE 19543784 A1 disclose plugging a transceiver module onto the diagnostic interface of a motor vehicle. The transceiver module provides a wireless communication link to a diagnostic system, via an infrared modem. The connection setup and the transmission of data are initiated and controlled by the diagnostic system by a service employee inputting corresponding instructions. The fault memories of the control units in the vehicle are also read out by the diagnostic system and can, for example, be displayed to the driver of the vehicle in the vehicle reception and can be used to generate a repair order.

Based on the abovementioned prior art, one object of this invention is to provide a diagnostic system with improved functions for the transmission of data and with targeted input possibilities, in customer reception, vehicle production or a workshop.

This and other objects and advantages are achieved by the diagnostic system according to the invention, which includes a transmission module with an integrated microcomputer and short diagnostic test program. The transmission module is connected to the diagnostic interface of the motor vehicle, and diagnostic data are called automatically from the control units in the vehicle by the short diagnostic test program, and read out. The result of this short diagnostic test is transmitted to an external offboard diagnostic system via a communication link from the transmission module, and is further processed by a more extensive diagnostic program. The result of this further processing is displayed on a computing system connected to the diagnostic system, in the customer reception portion of a service company.

The more extensive diagnostic algorithm displays to the service employee the read-in short test result on a display of the computer system in the customer reception; that is, the individual fault messages are displayed in a selectable, alternative program loop in the form of a selection menu with an input mask. The service employee can then request further information about individual fault messages from the driver of the vehicle in the customer reception, and can input the interrogated customer complaints into the more extensive diagnostic system as additional fault symptoms for the respectively selected fault message.

A more extensive diagnostic system which is suitable for this purpose is disclosed for example, in German patent document DE 102005015664, mentioned previously, if it is supplemented with the short diagnostic test system components disclosed here and with the possibilities of reading the result of the short diagnostic test into the transmission module and out of said module. The customer complaints are then input into the rest of the diagnostic process.

Alternative possible uses of the diagnostic system according to the invention with the short diagnostic test are apparent on the production line of the vehicle production for quality assurance and troubleshooting on the assembly line or during the repair process in a service company. The latter variant can then be beneficial if correct customer reception does not occur in the service company, because, for example, the driver of the vehicle merely leaves his vehicle on the yard of the workshop and puts his vehicle key into a reception letterbox at the workshop, without going to the customer reception.

In a first embodiment variant, the transmission module can buffer the result of the short diagnostic test in a memory area in the module. After buffering has taken place, the transmission module is removed from the diagnostic interface of the motor vehicle and connected with a data line to a computer system of the diagnostic system. After the transmission module and diagnostic system have been identified, the result of the short diagnostic test is read into the offboard diagnostic system and further processed. Customer complaints in the form of fault symptoms are input and also taken into account in the following diagnostic process. This embodiment variant has the advantage that there is no need for a wire-free connection, such as, for example, a WLAN connection, between the transmission module and diagnostic system.

In another embodiment, a WLAN (Wireless Local Area Network) interface is integrated into the transmission module. In this case, the result of the short diagnostic test is transmitted into a computer system of the offboard diagnostic system using the bus protocol of the WLAN interface and via the transceiver unit, the offboard diagnostic system also being equipped with a WLAN interface for this purpose. In a WLAN interface, it is possible, under certain circumstances, to dispense with buffering of the short diagnostic test result.

The WLAN connection is preferably set up and established from the transmission module on the vehicle to a computing system in the customer reception of the service company. Establishment of the connection, and the monitoring and control of the transmission of data, are carried out automatically by means of the program module of the short diagnostic test after its connection to the diagnostic interface of the motor vehicle, without a service employee having to also issue control instructions for this purpose. This embodiment has the advantage that the transmission module can remain on the vehicle, and the transmission of data does not require physically transporting the transmission module.

Instead of the WLAN interface, other wire-free communication links such as, for example, mobile radio or, to a restricted degree, Bluetooth can also be used. New future wire-free communication systems are not ruled out either provided that they are suitable for transmitting data and that they meet the telecommunication approval conditions.

In a third alternative of the invention, the result of the short diagnostic test is first buffered in a storage medium on the transmission module, and only after the short diagnostic test is ended are the diagnostic data and the short test result transmitted via the WLAN interface to a WLAN interface of the offboard diagnostic system and further processed there by the more extensive diagnostic program. This embodiment has the advantage that the execution of the short diagnostic test and the transmission of the short test result are largely independent of the readiness of a WLAN receiver unit to receive. If the offboard diagnostic system is temporarily not ready to receive a data transmission, the data transmission for the buffered short test result can be repeated at any desired number of later times.

The interaction of the various components of the diagnostic system according to the invention will be explained in more detail below with reference to drawings. A possible method sequence for the diagnostic process in the customer reception will also be presented.

### BRIEF DESCRIPTION OF THE DRAWINGS

FIG. 1 is a schematic illustration of a diagnostic system according to the invention; and

FIG. 2 illustrates a possible method sequence in the customer reception of a service company.

### DETAILED DESCRIPTION OF THE DRAWINGS

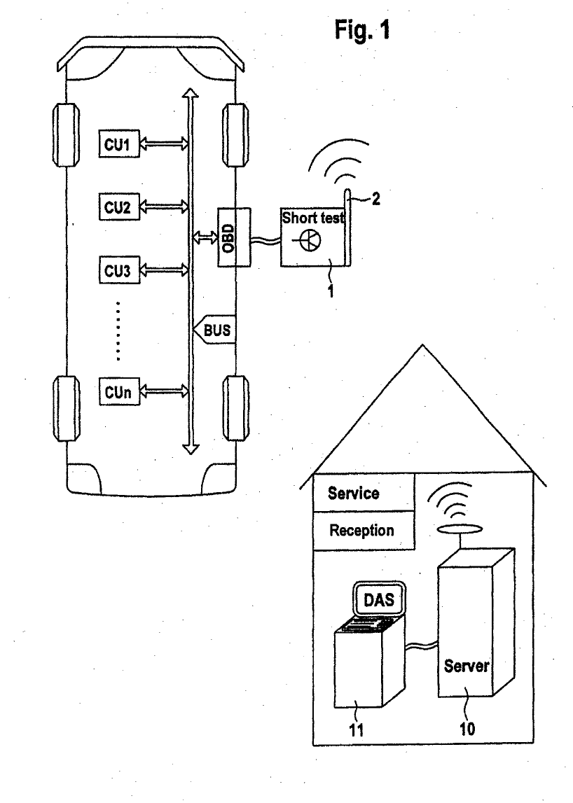

An exemplary embodiment of the diagnostic system according to the invention is illustrated in FIG. 1. In a motor vehicle onboard power system, a plurality of control units or microcontrollers CU1, CU2, CU3, . . . CUn perform different tasks and functions in the vehicle. Each of these control units has a self-diagnostic routine by which it can self-check its functions, detect predefined faults, and classify them with a fault code. These possibly detected fault codes are stored in fault memories in the onboard power system. The various control units are connected to one another in data communication via at least one data bus. However, they can also be networked with one another via a plurality of different bus systems, in which case gateways are provided at the junction between two different bus systems to translate the different bus protocols. Via a diagnostic interface OBD, it is then possible to access the communication network in the motor vehicle from the outside with a diagnostic tester and therefore to access the connected control units and read out their fault memories.

According to the invention a portable transmission module 1 with an integrated microcomputer system and an implemented short diagnostic test program is connected to the diagnostic interface of the motor vehicle onboard power system. The short diagnostic test includes collecting the fault memory data and other vehicle data from the connected control units and, if appropriate, also logging fault messages on the bus systems of the onboard power system. In one embodiment it also buffers the collected diagnostic data in a suitable medium in the transmission module. In addition to the collected data, an identifier for the time of the short diagnostic test is also buffered.

After the transmission module is connected, the ignition in the motor vehicle onboard power system remains switched on, and the control units remain in the awake mode. Under this precondition, after the transmission module has been connected, the short diagnostic test can be started by the service technician, who connects the transmission module by pressing on a button. The short diagnostic test and the transmission of data then occur automatically. It is also conceivable that in a further automated embodiment the transmission module automatically detects that it has been placed in contact with a motor vehicle onboard power system, and automatically starts the short diagnostic test after a connected motor vehicle onboard power system has been detected.

In one embodiment, the result of the short diagnostic test can be buffered on a memory medium of the transmission module. In this case, in the further diagnostic process the transmission module is disconnected again from the diagnostic interface of the motor vehicle and moved to a computing system of the offboard diagnostic system. Here, the transmission module is connected to the computing system and the result of the short diagnostic test is read out of the memory of the transmission module into the offboard diagnostic system, and further processed by it.

In a preferred embodiment of the transmission module, a transceiver unit with an associated transmission interface on a WLAN (Wireless Local Area Network) basis is integrated into the transmission module. Data are then transmitted in a wireless link via an antenna 2 in or on the transmission module and a transceiver unit which is connected to the offboard diagnostic system. In addition to a transceiver unit, a memory, with which the result of the short diagnostic test is buffered in a non-volatile fashion before the short test result is transmitted via the WLAN interface and the transceiver unit, can be made available in the transmission module.

The offboard diagnostic system may be a distributed system with distributed and networked hardware components, and distributed and networked program modules. In the service company in which the motor vehicle diagnosis is carried out there is usually a workshop server 10, one or more computer systems 11 in the vehicle reception area and a plurality of diagnostic testers with which, eventually, the detailed workshop diagnosis and the service are carried out. These three units are generally networked to one another.

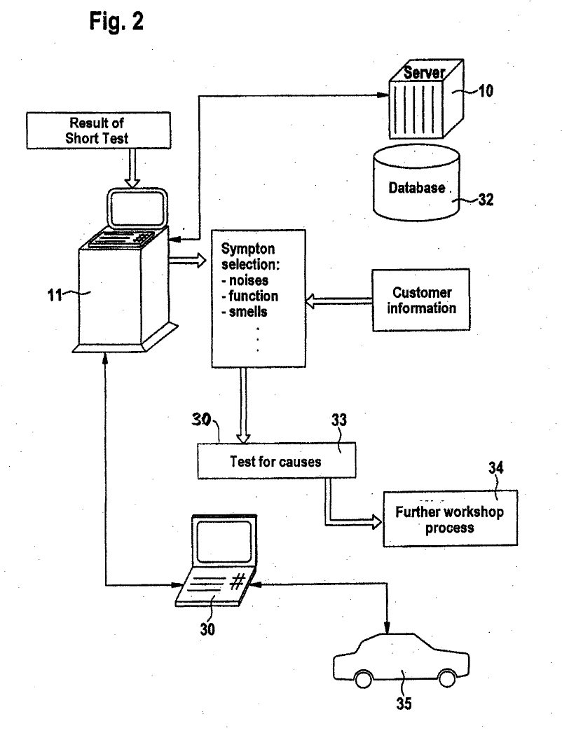

The connection of the short diagnostic test to an offboard diagnostic system and to a computer system in the customer reception area, which is effected by the transmissions module, permits, in the customer reception area, for example a working sequence such as is illustrated in FIG. 2. The result of the onboard short diagnostic test is read into the computer system 11 installed in the customer reception and is already prepared there by a program module of the diagnostic program running in the background. The extent to which the short test result is processed depends on the particular offboard diagnostic system which is used. In all cases, according to the invention the result of the short test with its fault messages is displayed to the service employee, including a selection menu from which he or she can select individual menu items and can input further machine-processable customer information for these selected menu items. (Such customer information can be obtained from the driver of the vehicle, for example, when he or she delivers the vehicle key at the customer reception.) The machine processability of the customer information can be ensured with an input mask in that the offboard diagnostic program, which runs in the background, interrogates further ambient data relating to a selected reported fault in a menu. For such ambient data the service technician can enter the corresponding alternative satisfied or not satisfied in a selection menu on the system display during the questioning of the customer. One possible way of doing this is, for example, a selection of symptoms, in which symptoms such as noises, functioning or non-functioning functions, smells etc. are acquired from the customer information.

The information, symptoms and diagnostic data which are acquired in this way are processed by the diagnostic program, which can run, for example, on a server 10, by evaluating an associated database 32. Alternatively, or in addition such, information, symptoms and diagnostic data may be fed to a diagnostic tester 30, which is connected to the diagnostic interface of the motor vehicle 35, for more wide-ranging workshop diagnosis and repair. With the tester it is then possible to perform selective cause tests 33 and to generate the further workshop process 34 from the test results.

The database 32 can be used to supplement and enrich the data of the short diagnostic test. For example, service data which are stored for the vehicle to be examined, such as approval date, MOT/exhaust emission deadlines or customer data, can be called and displayed in the customer reception area on the computer system there. This permits the service employee in the customer reception area to advise the customer better and more selectively.

Further conditioning of the data from the short diagnostic test is done by supplementing it with data relating to the identification of the vehicle (VIN), odometer reading, filling level of the fuel tank, and service work which has already been carried out in the past. The conditioned and supplemented data are subsequently passed on to the subsequent processes such as production of orders, invoicing and detailed workshop diagnostics.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-8. (canceled)

9. A motor vehicle diagonistic system comprising:
onboard components; and
offboard components; wherein,
the onboard components are connected to one another via communication links; and
the offboard components have a communication link to one another;
one of the offboard components is a transmission module which is connectable to a diagnostic interface of a motor vehicle onboard power system;
a short diagnostic test program, which reads out diagnostic data from the onboard components and combines them to form a short diagnostic test result, is implemented in the transmission module; and
the short diagnostic test result is read into at least one of the offboard components and is further processed by an offboard diagnostic program.

10. The diagnostic system as claimed in claim 9, wherein the short diagnostic test result is read into a computer system in a customer reception function of a service company.

11. The diagnostic system as claimed in claim 9, wherein:
the short diagnostic test result is buffered in the transmission module;
the transmission module is subsequently connected to an offboard component of the diagnostic system via a communication line; and
the short diagnostic test result is read out.

12. The diagnostic system as claimed in claim 9, wherein the transmission module contains a transceiver unit with which transmits the short diagnostic test result via a wireless link to an offboard component of the diagnostic system.

13. The diagnostic system as claimed in claim 12, wherein the short diagnostic test result is buffered in a storage medium of the transmission module, and is subsequently transmitted via the transceiver unit.

14. The diagnostic system as claimed in claim 12, wherein data are transmitted via a WLAN interface.

15. The diagnostic system as claimed in claim 9, wherein the short diagnostic test result is enriched by an offboard diagnostic program with further data, and is further processed.

16. The diagnostic system as claimed in claim 9, wherein for the short diagnostic test result, customer complaints are recorded in machine-processable form and input, and are also taken into account in said further diagnostic processing.

17. A diagnostic system for a vehicle that has a plurality of onboard control units which are coupled in data communication with each other and with an externally accessible diagnostic interface, each of said control units having a self diagnostic routine that can detect predefined faults and classify them according to fault codes, said diagnostic system comprising:
an offboard transmission module which is externally connectable with said diagnostic interface;
a short diagnostic test program that is stored in said transmission module, and is operable by said transmission module to read out diagnostic test data from said control units via said diagnostic interface, and to combine said diagnostic test data to form a short diagnostic test result; and
at least one offboard data processing component which reads said short diagnostic test result from said transmission module, and uses it to perform further diagnostic processing.

18. The diagnostic system as claimed in claim 17, said transmission module is coupled to said data processing component via a wireless communication link.

19. The diagnostic system as claimed in claim 17, wherein:
said transmission module includes a data buffer;
said short diagnostic test result is stored in said buffer; and
after said short diagnostic test result is stored, the transmission module is then connected to said data processing component which reads said short diagnostic test result from said buffer.
